(19) United States
(12) Patent Application Publication
(10) Pub. No.: US 2018/0146655 A1
(43) Pub. Date: May 31, 2018

(54) Systems, Devices, and/or Methods for Managing King Fishing From a Pier

(71) Applicant: Bradley Allen Crossen, Trinity, NC (US)

(72) Inventor: Bradley Allen Crossen, Trinity, NC (US)

(21) Appl. No.: 15/604,434

(22) Filed: May 24, 2017

Related U.S. Application Data
(60) Provisional application No. 62/312,589, filed on Mar. 24, 2016.

(51) Int. Cl. A01K 97/10; A01K 97/06; A01K 99/00

(52) U.S. Cl. CPC A01K 97/10; A01K 99/00; A01K 97/06

(57) ABSTRACT

Certain exemplary embodiments can provide a system, which comprises an anchor rod holder, which is constructed to hold a base portion of a king fishing Anchor Rod. When operatively mounted, the anchor rod holder causes the king fishing Anchor Rod to be substantially vertical relative to a surface of an ocean that is being fished from a pier. The system further comprises a fighting rod holder, which is constructed to be coupled to a king fishing Fighting Rod. In certain exemplary embodiments, the king fishing Fighting Rod sits at an angle less than substantially vertical relative to the surface of the ocean that is being fished.

### CROSS-REFERENCES TO RELATED APPLICATIONS

This application claims priority to, and incorporates by reference herein in its entirety, U.S. Provisional Patent Application Ser. No. 62/312589 (Attorney Docket No. 1126-01), filed Mar. 24, 2016.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a photograph of a perspective view of an exemplary embodiment of a system 1000;

FIG. 2 is a photograph of a perspective view of an exemplary embodiment of system 2000;

FIG. 3 is a sketch of a top view of an exemplary embodiment of a system 3000;

FIG. 4 is a sketch of a side view of an exemplary embodiment of a system 4000; and

FIG. 5 is a flowchart of an exemplary embodiment of a method 5000.

### DETAILED DESCRIPTION

Certain exemplary embodiments can provide a system, which comprises an anchor rod holder, which is constructed to hold a base portion of a king fishing Anchor Rod. When operatively mounted, the anchor rod holder causes the king fishing Anchor Rod to be substantially vertical relative to a surface of an ocean that is being fished from a pier. The system further comprises a fighting rod holder, which is constructed to be coupled to a king fishing Fighting Rod. In certain exemplary embodiments, the king fishing Fighting Rod sits at an angle less than substantially vertical relative to the surface of the ocean that is being fished.

From a pier, certain locations have regulations mandating two rods and reels for live bait king fishing (i.e., fishing primarily for king mackerel). One rod is used to cast an anchor line (the “Anchor Rod”). The Anchor Rod can be, for example, a 10-15 foot long surf type rod, using fishing line rated at approximately 20 pound test to sling an anchor that weighs between 4-8 ounces.

A bait is attached to a line of a rod used to hook fish (the “Fighting Rod”), which can be a medium to heavy action rod that is approximately 6-7′ foot with a 4/0-9/0 size reel and using fishing line such as approximately a 30 pound test rated line. Certain exemplary Fighting Rod reels hold 500 yards or more of monofilament line (e.g., monofilament rated at approximately 30 pound test).

A leader coupled to the Fighting Rod can be approximately 6-feet in length and can be a monofilament line rated at approximately 100 pound mono test and can be attached to approximately two feet of seven strand wire (e.g., rated at approximately 90 pound test) and two treble hooks (e.g., #4 treble hooks). There are numerous possible variations to rigging Anchor Rods and Fighting rods, but an underlying principle is to avoid damage caused by sharp fish teeth via use of a wire and avoid line breakage from rubbing against pier pilings (such as via the use of monofilament line rated at approximately 100 pound test).

A fisherperson takes the Anchor Rod and casts an anchor line out and secures the anchor line to an object on the sea bottom. The fisherperson then attaches a baited line coupled to the Fighting Rod to the anchor line. A rig of the baited line can comprise a loop clip, a weight, and a clothespin. The loop clip, which can be something like a shower curtain clip with weight, is coupled to the anchor line and the clothespin can be coupled to the bait line. An alternative is a release clip designed and sold for king fishing.

The fisherperson lowers the bait down to the water on the anchor line. The fisherperson can adjust the depth of the bait in the water by how far up the bait line the clothespin is coupled. Most fishermen keep baits down about 3-4 feet below the water's surface, but it's not uncommon to see baits on top or as far as approximately 6 feet below the surface.

A force of a striking fish can release the bait line from the clothespin. Take multiple clothespin/release clips—that way the fisherperson doesn't need to pull up the anchor line every time the fighting line releases from the clip.

Live baits of choice vary-but can comprise what is available from the pier at the time. For example, bluefish, pogies, spots, pinfish, and/or lizard fish can be used as baits.

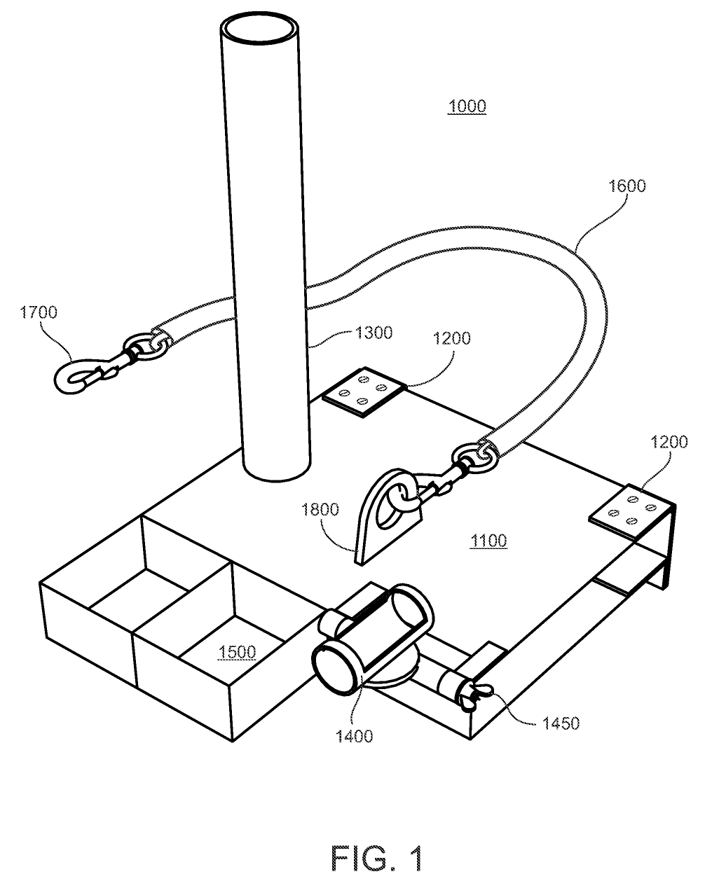

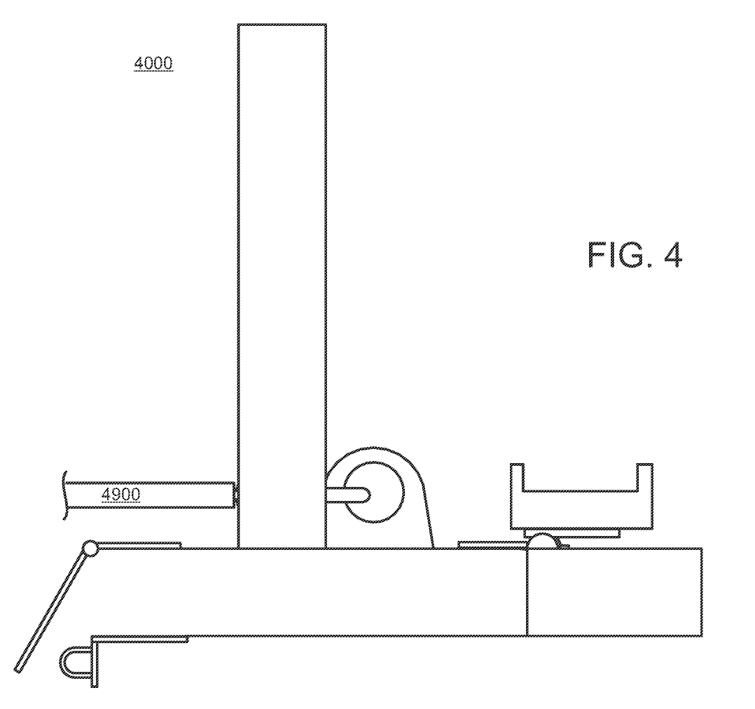

FIG. 1 is a photograph of a perspective view of an exemplary embodiment of a system 1000, which comprises a pier coupler 1100. Pier coupler 1100 comprises an anchor rod holder 1300, a fighting rod holder 1400, a divided utility tray 1500, a lanyard 1600, a lanyard clip 1700, and a lanyard anchor 1800. Pier coupler 1100 comprises a set of hinges 1200 that, via fasteners, can be coupled to a pier (e.g., pier 4900 of FIG. 4).

Anchor rod holder 1300 is constructed to hold a base portion of a king fishing Anchor Rod. When operatively mounted, anchor rod holder 1300 causes the king fishing Anchor Rod to be substantially vertical relative to a surface of the water that is being fished from a pier. Fighting rod holder 1400 is constructed to be coupled to a king fishing Fighting Rod. The king fishing Fighting Rod sits approximately parallel to the surface of the water being fished when coupled to pier coupler 1100. A wingnut 1450 can be used to couple and decouple the Fighting Rod to pier coupler 1100. Via wingnut 1450, jaws of fighting rod holder 1400 can be opened and closed thereby allowing for the Fighting Rod to be placed in and removed from fighting rod holder 1400.

Divided utility tray 1500 is constructed to hold fishing gear for quick access by the fisherperson. For example, clothespins, loop clips, and/or release clips can be placed in divided utility tray 1500 for convenient access.

A first end of lanyard 1600 is coupled to lanyard anchor 1800. Lanyard clip 1700 can be coupled to an anchor point on the pier to provide an additional restraint to resist motion of pier coupler 1100 relative to the pier.

Certain exemplary embodiments comprise:
anchor rod holder 1300, which is constructed to hold a base portion of a king fishing Anchor Rod; when operatively mounted, anchor rod holder 1300 causes the king fishing Anchor Rod to be substantially vertical relative to a surface of an ocean that is being fished from a pier;
fighting rod holder 1400, which is constructed to be coupled to a king fishing Fighting Rod; wherein the king fishing Fighting Rod sits at an angle less than substantially vertical relative to the surface of the ocean that is being fished;
one or more hinges 1200, which are constructed to couple system 1000 to the pier;
divided utility tray 1500, which is constructed to hold fishing gear for access by a fisherperson;
lanyard clip 1700;
lanyard 1600, which is coupleable to lanyard clip 1700;
lanyard anchor 1800, which is coupled to lanyard 1600; wherein lanyard clip 1700 is coupleable to an anchor point on the pier to provide an additional restraint to resist motion of system 1000 relative to the pier; and/or
wingnut 1450, which is used to couple and decouple the Fighting Rod to fighting rod holder 1400, etc.

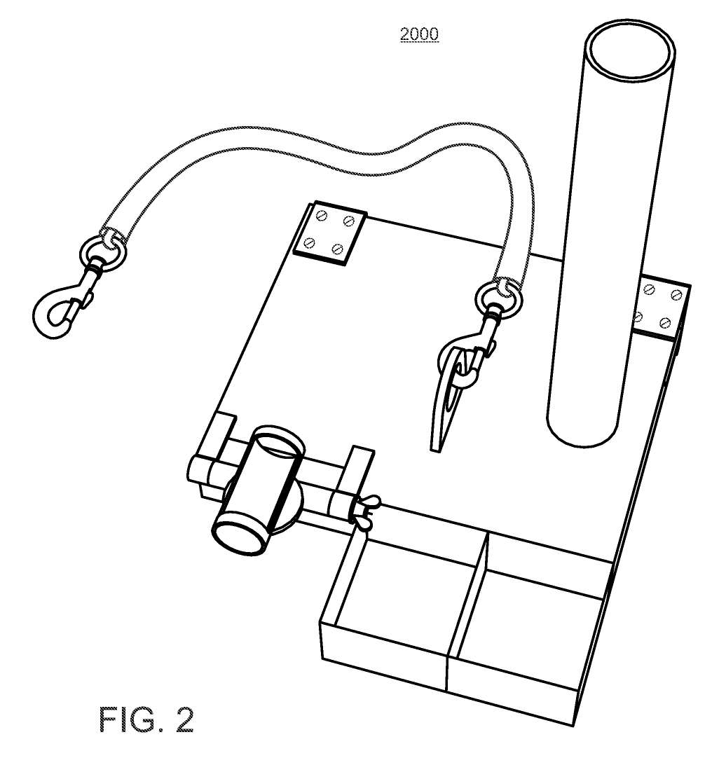

FIG. 2 is a photograph of a perspective view of an exemplary embodiment of system 2000.

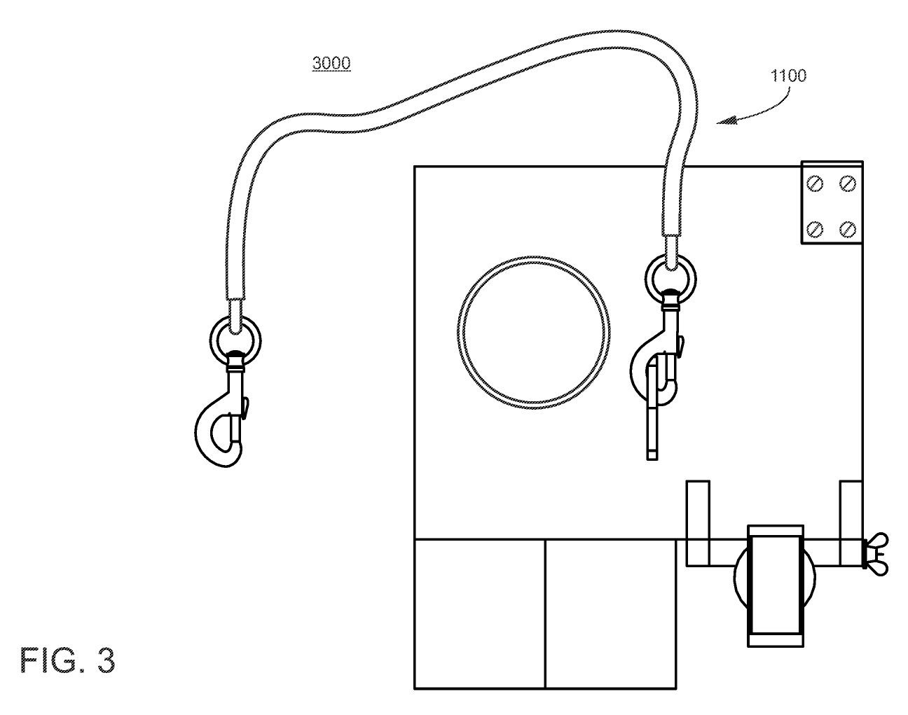

FIG. 3 is a sketch of a top view of an exemplary embodiment of a system 3000; and

FIG. 4 is a sketch of a side view of an exemplary embodiment of a system 4000.

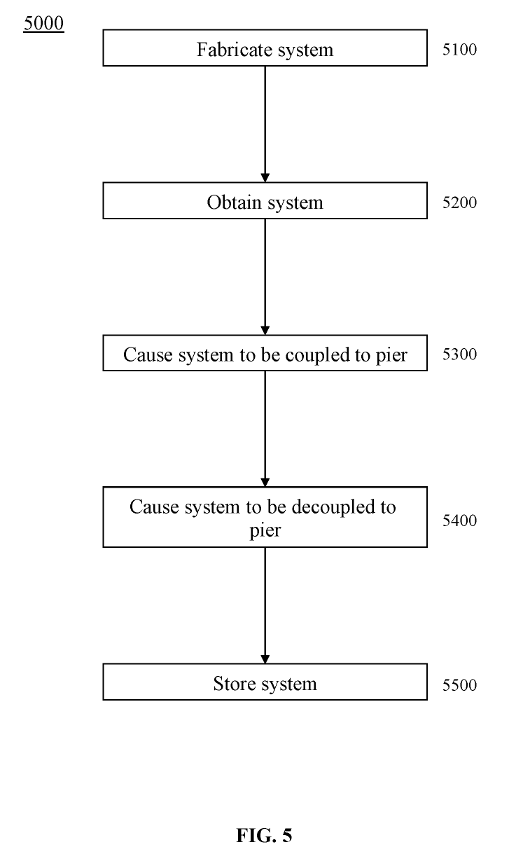

FIG. 5 is a flowchart of an exemplary embodiment of a method 5000. At activity 5100, a system can be fabricated. At activity 5200, a fisherperson can obtain the system. At activity 5300, certain exemplary embodiments can cause the system to be coupled to a pier. The system can comprise:
an anchor rod holder, which is constructed to hold a base portion of a king fishing Anchor Rod; when operatively mounted, anchor rod holder causes the king fishing Anchor Rod to be substantially vertical relative to a surface of an ocean that is being fished from a pier;
a fighting rod holder, which is constructed to be coupled to a king fishing Fighting Rod; wherein the king fishing Fighting Rod sits at an angle less than substantially vertical relative to the surface of the ocean that is being fished;
one or more hinges, which are constructed to couple the system to the pier;
a divided utility tray, which is constructed to hold fishing gear for access by a fisherperson;
a lanyard clip;
a lanyard, which is coupleable to the lanyard clip;
a lanyard anchor, which is coupled to the lanyard; wherein the lanyard clip is coupleable to an anchor point on the pier to provide an additional restraint to resist motion of the system relative to the pier; and/or
a wingnut, which is used to couple and decouple the Fighting Rod to the fighting rod holder, etc.

At activity 5400, the system can be decoupled from the pier. At activity 5500, the system can be stored until the fisherperson desires to return to fishing, such as from the pier.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapter—a device used to effect operative compatibility between different parts of one or more pieces of an apparatus or system.
additional—supplemental or extra.
anchor—a device that restrains motion of an object via a weight.
anchor point—a location to which an object can be coupled such that motion is restrained.
anchor rod—a fishing pole that is coupled to an anchor line, the anchor line to which a weight is attached in order to attempt to hold the anchor line on a bottom of an ocean.
and/or—either in conjunction with or in alternative to.
apparatus—an appliance or device for a particular purpose
associate—to join, connect together, and/or relate.
base portion—a part of a fishing pole that is below where a reel is mounted and is constructed to be secured via a mount to a surface.
can—is capable of, in at least some embodiments.
cause—something that produces an effect, result, or condition.
clip—a device that couples a first object to a second object.
comprising—including but not limited to.
configure—to make suitable or fit for a specific use or situation.
connect—to join or fasten together.
constructed to—made to and/or designed to.
couple—to join, connect, and/or link together.
decouple—to unjoin, disconnect, and/or unlink from being together.
define—to establish the outline, form, or structure of
device—a machine, manufacture, and/or collection thereof.
divided utility tray—a partitioned container that comprises walls in which articles can rest.
fighting rod—a fishing pole that is coupled to a fishing line, the fishing line to which a bait is attached in order to attempt to catch a fish.
fish—to attempt to catch a water vertebrate with gills.
fisherperson—an individual attempting to catch a water vertebrate with gills.
fishing gear—supplies that are usable to attempt to catch a fish.
generate—to create, produce, give rise to, and/or bring into existence.
hinge—hinge is a mechanical bearing that connects two solid objects.
holder—a receptacle constructed to restrain motion of a fishing rod in at least two mutually perpendicular directions.
install—to connect or set in position and prepare for use.
king fishing—attempting, via a fishing rod, to catch a king fish (i.e., a king mackerel).
lanyard—a cord or rope.
may—is allowed and/or permitted to, in at least some embodiments.
method—a process, procedure, and/or collection of related activities for accomplishing something.
ocean—a sea.
pier—a walkway jutting into an ocean.
plurality—the state of being plural and/or more than one.
predetermined—established in advance.
provide—to furnish, supply, give, and/or make available.
relative—compared to.
repeatedly—again and again; repetitively.
resist motion—to restrain from changing locations.
restraint—something that causes a resistance to motion.
set—a related plurality.
sit—to rest an object on.
substantially—to a great extent or degree.
support—to bear the weight of, especially from below.
system—a collection of mechanisms, devices, machines, articles of manufacture, processes, data, and/or instructions, the collection designed to perform one or more specific functions.
wingnut—a type of fastener that defines a threaded aperture, the fastener comprises two ears, one on each side, so the fastener can be tightened or loosened by hand substantially without tools.
vertical—substantially at a right angle relative to a horizon.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
an anchor rod holder constructed to hold a base portion of a king fishing Anchor Rod, when operatively mounted, the anchor rod holder causing the king fishing Anchor Rod to be substantially vertical relative to a surface of an ocean that is being fished from a pier;
a fighting rod holder constructed to be coupled to a king fishing Fighting Rod, wherein the king fishing Fighting Rod sits at an angle less than substantially vertical relative to the surface of the ocean that is being fished; and
a hinge constructed to couple the system to the pier.

2. The system of claim 1, further comprising:
a divided utility tray constructed to hold fishing gear for access by a fisherperson.

3. The system of claim 1, further comprising:
a lanyard clip;
a lanyard coupleable to the lanyard clip; and
a lanyard anchor coupled to the lanyard, wherein the lanyard clip is coupleable to an anchor point on the pier to provide an additional restraint to resist motion of the system relative to the pier.

4. The system of claim 1, wherein:
a wingnut is used to couple and decouple the Fighting Rod to the fighting rod holder.

5. A method comprising a plurality of activities, comprising:
causing a system to be coupled to a pier, the system comprising:
an anchor rod holder constructed to hold a base portion of a king fishing Anchor Rod, when operatively mounted, the anchor rod holder causing the king fishing Anchor Rod to be substantially vertical relative to an ocean that is being fished from the pier;
a fighting rod holder constructed to be coupled to a king fishing Fighting Rod, wherein the king fishing Fighting Rod sits approximately parallel to a surface of water being fished when coupled to the system; and
a hinge constructed to couple the system to the pier.
